(19) United States
(12) Patent Application Publication
(10) Pub. No.: US 2020/0350806 A1
(43) Pub. Date: Nov. 5, 2020

(54) METHOD AND DEVICE FOR AUTOMATICALLY PRODUCING A STATOR OF AN ELECTRIC MACHINE

(71) Applicant: Miba Automation Systems Ges.m.b.H., Laarkirchen (AT)

(72) Inventors: Andreas Falkner, Wels (AT); Mladen-Mateo Primorac, St. Pölten (AT); David Scherrer, Gmunden (AT)

(21) Appl. No.: 16/643,514

(22) PCT Filed: Aug. 10, 2018
(86) PCT No.: PCT/AT2018/060188

§ 371 Date: Feb. 28, 2020

(30) Foreign Application Priority Data
Sep. 1, 2017 (AT) A50739/2017

(51) Int. Cl. H02K 15/00

(52) U.S. Cl. CPC H02K 15/0087

(57) ABSTRACT

The invention relates to a method and a device for the automated manufacturing of a semi-finished product of a stator (1) of an electrical machine. A substantially hollow-cylindrical laminated core (2) with a plurality of stacked sheet metal segments (2′) defining a main axis (6) is provided. Rod-shaped conductor elements (3, 4) for the construction of an electrical winding protrude with at least one of their longitudinal ends (11, 12; 13, 14) with respect to the first and/or second end face (7, 8) of the laminated core (2), so that they form conductor protrusions (15, 16; 17, 18) with respect to the laminated core (2) at at least one of the end faces (7, 8) of the laminated core (2). These conductor protrusions (15, 16; 17, 18) of the conductor elements (3, 4) are bent in the direction of the circumferential direction of the hollow-cylindrical laminated core (2) by means of at least one bending tool (25, 25; 26, 26′) mounted rotatably about an axis of rotation (27). In addition, the longitudinal ends (11, 12; 13, 14) of the conductor elements (3, 4) are brought into a predefined target radial position relative to the laminated core (2) by calibrating forces acting radially in the direction towards the axis of rotation (27) and exerted by at least one calibration device (28, 29) with controllably adjustable calibrating fingers (30, 31) aligned radially with respect to the axis of rotation (27) of the at least one bending tool (25, 25′, 26, 26′).

The invention relates to a method and device for the automated manufacturing of a semi-finished product of a stator of an electrical machine, as indicated in claims 1 and 8.

From JP2003259613A a manufacturing method for the electrical winding of the stator of an electrical machine is known. A plurality of essentially U-shaped conductor elements are inserted into the receiving grooves of the hollow-cylindrical stator laminated core. The protrusions of the leg ends of the U-shaped bent conductor elements protruding on one of the two end faces of the stator laminated core are then bent along the circumferential direction of the stator laminated core by means of concentrically arranged, disc-shaped bending tools, whereby protrusions of the conductor elements directly adjoining one another in the radial direction of the stator laminated core are bent in opposite circumferential directions so that crossed conductor protrusions are created. Selective electrical connection of the protrusions of the conductor elements creates at least one winding extending in the circumferential direction of the stator laminated core. This manufacturing process can only be automated to a limited extent or can only be automated with a relatively high technical effort and only by adhering to narrow tolerances of the U-shaped bent conductor elements.

In U.S. Pat. No. 2,270,472 A a method and a machine for manufacturing the rotor of an electrical machine is disclosed. The winding of the rotor is designed as a bar winding with crossed cable ends for connection to the commutator of the rotor. This method is also only partially satisfactory in terms of the achievable manufacturing cycle times.

The task of the present invention was to overcome the disadvantages of the state of the art and to provide a method and a device for the manufacturing of stators for electrical machines which is as functionally stable as possible, precise, and fast.

This task is solved by a process and a device according to the claims.

The method according to the invention enables an automated or at least partially automated manufacturing of a stator of an electrical machine or at least one corresponding semi-finished or intermediate product can be produced. In accordance with one of the steps in the manufacturing method, a substantially hollow-cylindrical laminated core is provided with a plurality of stacked sheet metal segments defining a major axis. The laminated core has a plurality of receiving grooves for conductor elements of an electrical winding, which receiving grooves are distributed in the circumferential direction of the laminated core and extend between a first and second axial end face of the laminated core.

The conductor elements protrude with at least one of their longitudinal ends opposite the first and/or second end face of the laminated core and thus form conductor protrusions with respect to the laminated core at at least one of the end faces of the laminated core.

In a further method step, the conductor protrusions of the conductor elements are bent in the direction of the circumferential direction of the hollow-cylindrical laminated core by means of at least one bending tool mounted so as to be rotatable about an axis of rotation.

In addition, the longitudinal ends of the conductor elements are brought into a predefined target radial position relative to the laminated core by calibrating forces acting radially towards the axis of rotation and exerted by at least one calibration device with controllably adjustable calibrating fingers aligned radially with respect to the axis of rotation of the at least one bending tool.

The advantage of the method steps selected here is that the bending and calibration process for the longitudinal and conductor ends of the rod-shaped conductor elements is combined or implemented in a structurally combined bending and calibration device. While the rotatably mounted bending tools are responsible for the plastic bending or deformation of the conductor ends along the circumferential direction of the laminated core, the translationally adjustable calibration fingers of the at least one calibration device are provided for moving the conductor ends or longitudinal ends of the conductor elements into their target radial position or as close as possible to their target radial position relative to the laminated core.

The measures according to claim 2 are also advantageous, as they enable a reliable and at the same time particularly precise positioning of the longitudinal ends of the conductor elements at the respective target positions relative to the laminated core. In particular, the longitudinal ends of the conductor elements are still held at the respective target circumferential positions by the bending tools, while the calibration device or its calibration fingers press or force the longitudinal ends of the conductor elements into the respective target radial position.

The measures according to claim 3 are also advantageous, as they allow sufficiently high calibration forces to be built up or exerted in order to be able to build up the respective target positions of the longitudinal ends of the conductor elements even with relatively short conductor protrusions. By means of the support mandrel which is arranged or can be arranged in the inner circle of the conductor elements, which can be designed in particular in disc form, a precise, stable and structurally simple abutment or a defined limiting stop for the longitudinal ends of the conductor elements can be achieved which are pushed in the direction of the main axis of the laminated core.

The measures according to claim 4 enable a simple insertion of the support mandrel into the ring arrangement or into the innermost layer of conductor elements. In addition, the conductor elements can be pushed sufficiently far towards the main axis of the laminated core during the calibration process so that they are at the planned radial target position or closer to the planned radial target position due to elastic spring back after the calibration forces have ceased.

The measures according to claim 5 are also appropriate, because they allow at least a slight expansion or spreading of the conductor protrusions relative to the laminated core during the insertion of the support mandrel. In particular, this allows the longitudinal ends of the innermost layer(s) to be approximated in the direction of the longitudinal ends of the outermost layer(s). In particular, this makes it easy to apply a calibrating force to the longitudinal ends of the conductor elements, which acts radially outwards in relation to the main axis of the laminated core.

With the measures according to claim 6, it is advantageous that the forces or torques acting on the laminated core in the course of the bending process of the conductor protrusions can be kept relatively low. In particular, the forces acting on a holding device for the laminated core can be kept as low as possible in a simple and effective manner. As a result, the holding and clamping forces which must act on the laminated core or its sheet metal segments can be kept relatively low.

An advantage of the measures according to claim 7 is that the forces acting on the bending device can be absorbed by relatively simple structural means, and in particular can be dissipated into ground sections. Especially in comparison to vertically aligned rotary or main axes, comparatively simpler and slimmer machine bodies can be constructed. A further advantage of the specified measures is that the weight of the laminated core is at least approximately evenly distributed over both bending or calibration devices.

Irrespective of the stated procedural measures, the task of the invention is also solved by a device for the automated manufacturing of a semi-finished product of a stator of an electrical machine.

This device has a support frame for holding at least one bending tool mounted so as to be rotatable about an axis of rotation, the at least one bending tool being hollow-cylindrical or cup-shaped and having, on one end face of its hollow-cylindrical portion, a plurality of radially with respect to the axis of rotation extending driving webs which are arranged in a distributed manner in the circumferential direction of the latter and extend radially to the axis of rotation. Clearances are formed between each of the driving webs adjoining one another in the circumferential direction, which clearances are provided for receiving sections or longitudinal ends of conductor elements to be bent with the bending tool.

In addition, at least one movement drive is implemented for the at least one rotatably mounted bending tool, wherein at least one electronic control device is designed for the controlled activation of the at least one movement drive.

It is essential that the at least one bending tool is surrounded, on its outer circumference, by at least one calibration device. This at least one calibration device comprises a plurality of calibration fingers aligned radially with respect to the axis of rotation of the at least one bending tool. These calibration fingers are adjustable in the direction towards the axis of rotation and in the direction away from the axis of rotation by means of at least one actuator.

The technical and beneficial effects which can be obtained by these means are indicated in the preceding and following parts of the description.

The measures according to claim 9 are also useful, as they allow the at least one calibration device to be arranged around the at least one bending tool. This allows the calibration process to be carried out without having to remove the laminated core from the bending device or having to transfer it to another location. This allows the precision and also the throughput speed of the manufacturing line to be increased.

With the measures according to claim 10, it is advantageous that a reliable and at the same time as precise as possible radial calibration of the conductor ends in relation to the laminated core can be achieved. In addition, due to the simultaneous calibration movements that can be carried out in relation to all the conductor elements in the laminated core, the shortest possible cycle times can be achieved. In addition, an alternating bending and calibration process can be carried out without significant delays or pauses.

An advantage of the measures according to claim 11 is that they implement a low-cost and yet sufficiently powerful actuator for the calibration device. The control requirements can also be kept relatively low by the measures specified.

The features according to claim 12 are also advantageous, as they create a structural module or a common structural unit in which the bending device and also the calibration device are integrated. In particular, this eliminates the need to re-clamp or transfer the laminated core with the conductor elements between a bending device and a calibration device, which results in higher precision and improved cycle times.

For a better understanding of the invention, it is explained in more detail by means of the following figures.

They each show in a strongly simplified, schematic representation:

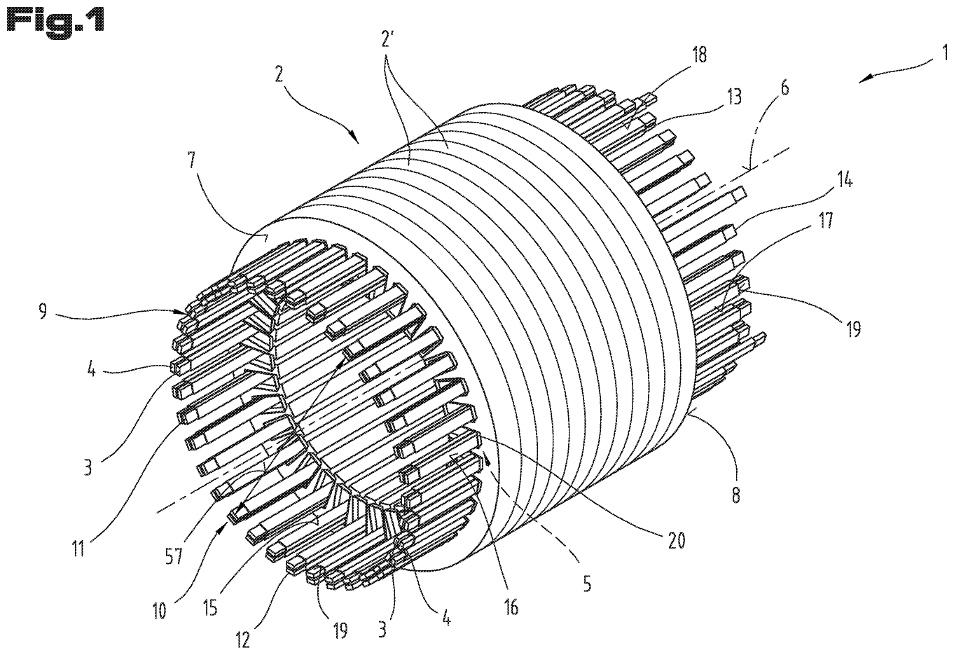

FIG. 1 a hollow-cylindrical laminated core with a plurality of rectilinear conductor elements accommodated therein in their not yet bent state, in graphic representation;

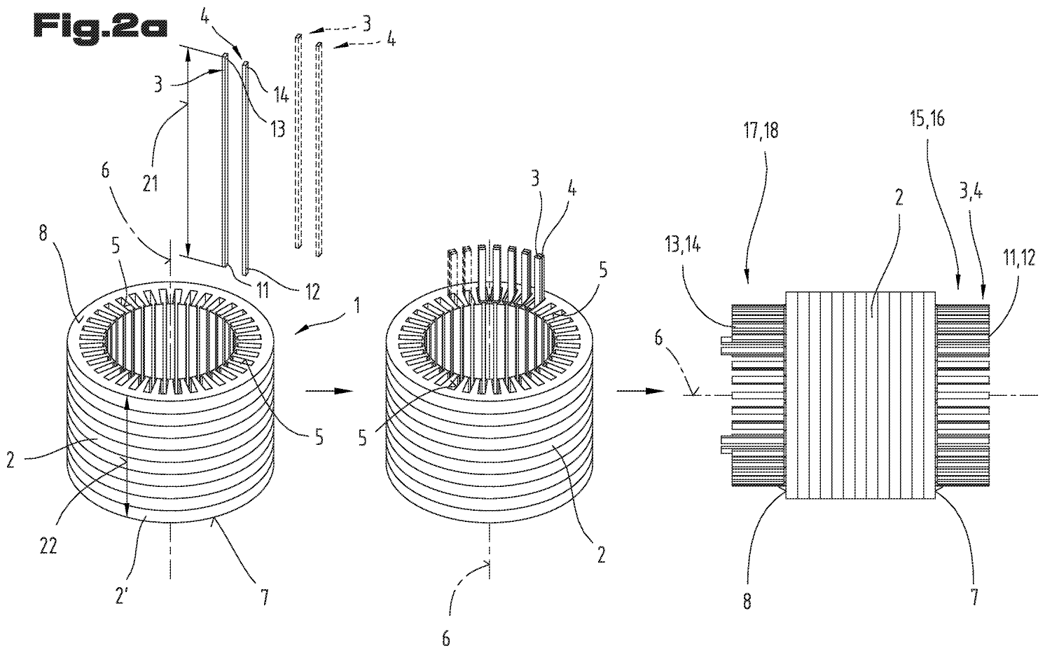

FIG. 2a individual method steps for manufacturing a stator of an electrical machine;

FIG. 2b a device for bending the conductor portions protruding from a laminated core and a stator semi-finished product manufactured with this device with bent conductor portions protruding from the laminated core;

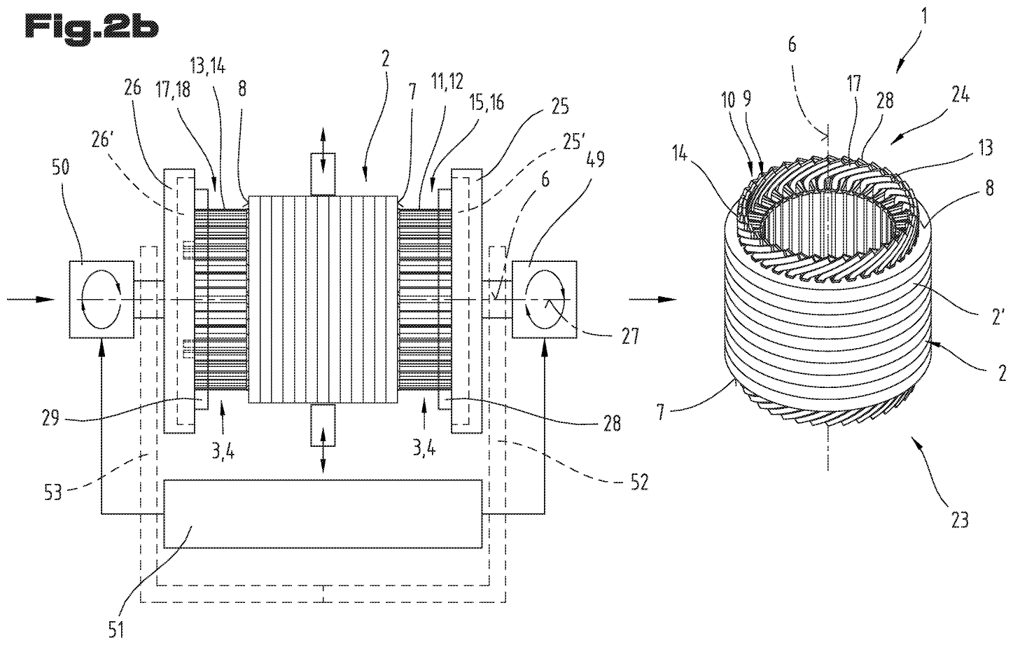

FIG. 3 two opposite units of combined bending and calibration devices for the automated manufacturing of a semi-finished stator product;

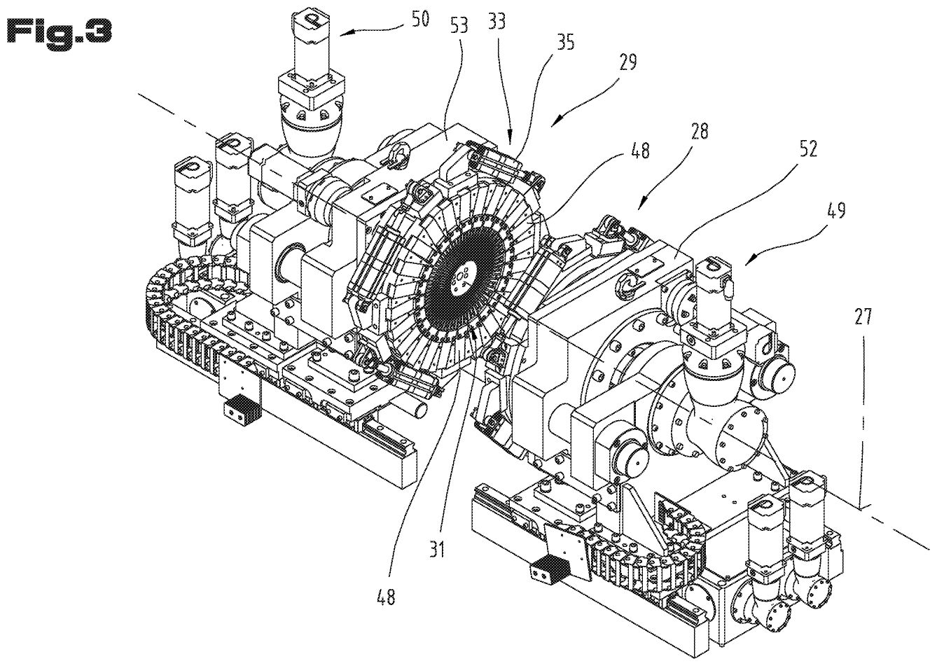

FIG. 4 the calibration device according to FIG. 3 in enlarged view;

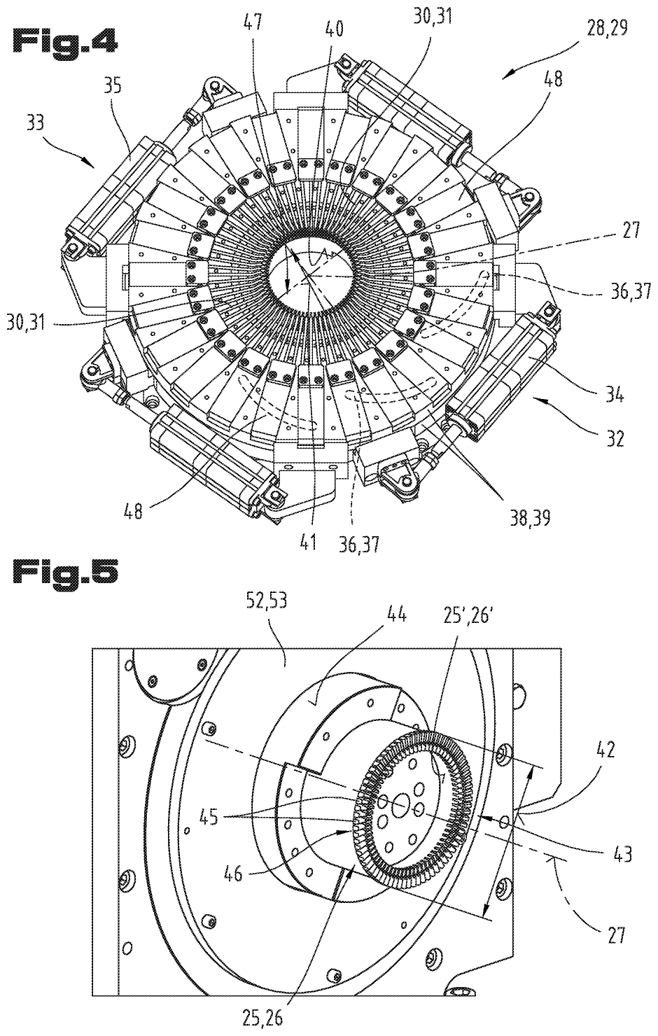

FIG. 5 the bending device according to FIG. 3 in enlarged view;

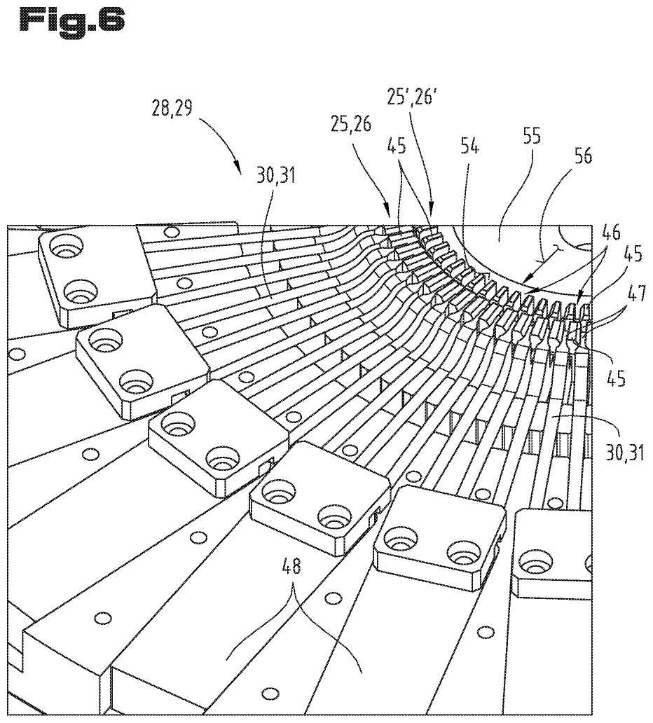

FIG. 6 a partial section of the calibration device according to FIG. 4.

As an introduction, it should be noted that in the differently described embodiment versions, identical parts are provided with the same reference numbers or the same component designations, whereby the disclosures contained in the entire description can be transferred analogously to identical parts with the same reference numbers or the same component designations. The positional information selected in the description, e.g. top, bottom, side, etc., is also related to the figure described and shown directly and must be transferred to the new position when the position is changed.

The term “in particular” is understood below to mean that it may be a possible more specific embodiment or specification of an object or a method step, but does not necessarily have to be a mandatory, preferred embodiment of the same or a mandatory procedure.

FIG. 1 shows a possible embodiment of a stator 1 to form an electrical machine not shown in detail.

The assembly and a plurality of manufacturing steps of stator 1 can preferably be carried out automatically in a complex manufacturing facility in several manufacturing stations, usually also fully automatically. In the following, not all of the overall process or manufacturing steps required to create a stator 1 ready for use are described, whereby the additionally required manufacturing steps can be derived from the state of the art.

Basically, stator 1 comprises a laminated core 2 and a plurality of conductor elements 3, 4 to be accommodated therein to form electrical coils or windings and to generate a rotating magnetic field as a result of current being applied to the coils or windings.

In the present embodiment example, the individual conductor elements 3, 4 are shown in their undeformed initial position, in which they are formed as straight bars. The bars usually have a rectangular cross-section up to a square cross-section and a longitudinal extension and are made of an electrically conductive material. In most cases this is a copper material. Therefore the conductor elements 3, 4 can also be called profile bars and the electrical winding built up with them can be called bar winding.

For the creation of electrical coils or of windings formed therefrom, a plurality of receiving grooves 5 are arranged or formed in a distributed way over the circumference in the laminated core 2, in each of which at least one of the conductor elements 3, 4, but preferably at least two of the conductor elements 3, 4, is or are received or arranged. The receiving grooves 5 can extend in the axial direction of the laminated core 2 in a parallel alignment with respect to a main axis 6 defined by the laminated core 2. However, it would also be possible to choose a non-parallel arrangement with respect to the main axis 6 of the receiving grooves 5 with the conductor elements 3, 4 to be accommodated in them. In any case, the receiving grooves 5 extend in the direction of the main axis 6 between the first end face 7 and the second end face 8 of the laminated core 2, which is arranged at a distance from it.

The receiving grooves 5 each have a receiving groove cross-section adapted to the cross-sectional dimensions of the conductor element 3, 4 or, if several conductor elements 3, 4 are located in the same receiving groove 5, each have a receiving groove cross-section adapted to the cross-sectional dimensions. The conductor elements 3, 4 per receiving groove 5 can be arranged one behind the other in radial direction with respect to the main axis 6, as shown in the example. However, it is also possible to arrange conductor elements 3, 4 in matrix or array form, in particular in rows and columns, in the individual receiving grooves 5.

The laminated core 2 is composed of a plurality of individual metal sheets or sheet metal segments 2′ electrically insulated against each other to form the core. The laminated core 2 is bounded in the direction of its main axis 6 by the first end face at its first end face 7 and by the second end face at its second end face 8, which is spaced apart from it. Preferably, the two end faces or end faces 7, 8 are arranged parallel to each other and in a plane oriented in the normal direction with respect to the main axis 6. In the present embodiment example of a stator 1 of an electrical machine, the laminated core 2′ forms a hollow cylinder with a substantially cylindrical inner surface and a cylindrical outer surface from the individual laminations or sheet metal segments 2′ stacked on top of each other.

As already mentioned above, at least one of the conductor elements 3, 4 is arranged in each of the receiving grooves 5. However, several, in particular two, three, four, five, six or even more conductor elements 3, 4 can be provided per receiving slot 5. In particular, eight, ten, twelve or more conductor elements 3, 4 can also be accommodated in each of the receiving grooves 5. As a minimum variant, only one conductor element 3 can be provided, although in this embodiment example, two conductor elements 3, 4 are shown and described in each of the receiving grooves 5. Thus, the radially inner conductor elements 3 form a first layer 9 and the radially outer conductor elements 4 form a second layer 10. Individual or a few of the receiving grooves 5 can also remain empty or can be designed without conductor elements 3, 4 inserted therein.

The rod-shaped conductor elements 3 and 4, which in their original state preferably run in a straight line, each have a first longitudinal end 11, 12 and a second longitudinal end 13, 14 opposite to each of the former. In this embodiment example, the first longitudinal ends 11, 12 protrude over the first end face 7 and the second longitudinal ends 13, 14 protrude over the second end face 8 of the laminated core 2. The conductor elements 3, 4 thus form first conductor protrusions 15, 16 opposite the first end face 7 and second conductor protrusions 17, 18 opposite the second end face 8.

The conductor elements 3, 4 accommodated in the individual receiving grooves 5 in the laminated core 2 and being still undeformed in their initial state, are interlocked with one another in the area of each of the two end faces 7, 8 of the laminated core 2 at their longitudinal ends 11, 12; 13, 14 and in relation to their conductor protrusions 15, 16; 17, 18 in a subsequent manufacturing step or bent along the circumferential direction of the laminated core 2. Subsequently, longitudinal ends 11 of the first or inner layer 9 are selectively electrically connected to corresponding longitudinal ends 12 of the second or outer layer 10. Preferably, the same can also be performed with the second longitudinal ends 13, 14 in the area of the second end face 8 of the laminated core 2.

In a known manner, the conductor elements 3, 4 can be provided with or surrounded by an electrical insulation layer 19, with the exception of mutual contact areas formed on them. This insulation layer 19 on the outer surface of the rod-shaped conductor elements 3, 4 is preferably made of plastic that may have been applied in a previous painting or dipping process. Furthermore, it can be advantageous if the individual conductor elements 3, 4, in addition to their electrical insulation layer 19 within the receiving grooves 5, are also preferably completely surrounded by a structurally independent, hollow profile-like insulation element 20.

The loading or insertion of the individual conductor elements 3, 4 into the respective receiving grooves 5 can be carried out step by step or cyclically, whereby the laminated core 2 is preferably in a horizontal orientation to its main axis 6. Since the typically undeformed, originally straight or bar-shaped conductor elements 3, 4 are accommodated in the respective receiving grooves 5 in a longitudinally displaceable manner, the relative position of the conductor elements 3, 4 in relation to the laminated core 2 must be taken into account when transferring them to a subsequent processing or manufacturing station, or a predefined relative position of the conductor elements 3, 4 in relation to the laminated core 2 must be ensured.

In a positioning step, which should preferably be carried out before transfer or forwarding to the subsequent processing or manufacturing station, the conductor elements 3, 4 can still be aligned in the axial direction with respect to one of the end faces 7, 8 of the laminated core 2.

This can be done, for example, by folding the laminated core 2 together with the conductor elements 3, 4 already accommodated therein from its preferably horizontal loading position into a vertical positioning position in which the main axis 6 of the laminated core 2 has a vertical longitudinal alignment. The laminated core 2 can be supported on a positioning attachment, whereby the conductor elements 3, 4 preferably come to rest by gravity in the individual receiving grooves 5 up to a preferably circumferential positioning element with one of their longitudinal ends 11, 12 or 13, 14. The distance between the positioning attachment and the positioning element must be selected according to the required or specified protrusion of the ends of the conductor elements 3, 4 over one of the end faces 7, 8 of the laminated core 2. This transport position can, for example, be assumed on a workpiece support which can be moved between individual work stations.

With the method steps listed below, as also shown schematically in FIGS. 2a and 2b, an automated or at least partially automated manufacturing of at least one semi-finished product of the generic stator 1 for electrical machines can be achieved. The corresponding method steps thus result in a semi-finished or intermediate product of a stator 1, which semi-finished product must be supplemented or completed by further process measures.

In an initial step, an essentially hollow-cylindrical laminated core 2 with a plurality of stacked sheet metal segments 2′ defining a main axis 6 is provided. This laminated core 2 has a plurality of receiving grooves 5 distributed in the circumferential direction and extending between the first axial end face 7 and the second axial end face 8 of the laminated core 2 for connection sections of an electrical winding to be manufactured. In the embodiment shown with a fixed stator 1 of an electrical machine or an electric drive motor, the laminated core 2 is designed as a hollow-cylindrical body. However, a stator can also be formed with an essentially cylindrical body shape, whereby the corresponding electrical machine or drive motor is then formed as a so-called external rotor motor with a hollow-cylindrical rotor.

In addition, a plurality of rod-shaped conductor elements 3, 4 are provided, which in their initial or original state, in particular in their inserted state compared to the laminated core 2, have a straight or predominantly straight shape, in particular a rod shape. These rod-shaped conductor elements 3, 4 can also be helical or screw-shaped, depending on the course of the receiving grooves 5, which is particularly the case with so-called diagonally grooved laminated cores 2 or stators 1 or rotors. The rod-shaped conductor elements 3, 4 each have a first longitudinal end 11, 12 and a distally opposite, second longitudinal end 13, 14. This plurality of rod-shaped conductor elements 3, 4 are provided for the construction of the electrical winding of stator 1 by means of predefined electrical connections or by connections still to be made subsequently. A length 21 of the rod-shaped conductor elements 3, 4 is greater than an axial length 22 of the laminated core 2.

In a preferably automated method step, the rod-shaped conductor elements 3, 4 are inserted in pairs or even in groups, in particular in a multiple of two, into preferably each of the receiving grooves 5. However, it is also possible that some of the receiving grooves 5 have fewer conductor elements 3, 4, or that some of the receiving grooves 5 have no conductor elements 3, 4. In the middle section of FIG. 2a, a partially executed insertion process of the conductor elements 3, 4 is shown or, for the sake of simplicity, only some of the conductor elements 3, 4 to be inserted into the laminated core 2 have been shown. The essentially straight or unbent, rod-shaped conductor elements 3, 4 are inserted into the receiving grooves starting from the first or second axial end faces 7, 8 of the laminated core 2. However, a combined insertion of individual conductor elements 3, 4 starting from the first end face 7 and individual conductor elements 3, 4 starting from the opposite, second end face 8 of the laminated core 2 is also possible. The slide-in or insertion process is therefore carried out in the axial direction of the laminated core 2, i.e. not in the radial direction with respect to the main axis 6 of the laminated core 2. In particular, the receiving grooves 5 generally have a taper of the clear cross section or clear width in the section closest to the main axis 6. This portion or end of the receiving grooves 5 is thus relatively slim or narrow, but nevertheless open, and in particular interrupted, as is generally known from the state of the art and can be seen in FIG. 2a, for example.

In a subsequent method step, the rod-shaped conductor elements 3, 4 inserted into the receiving grooves 5 are positioned in such a way that their first and second longitudinal ends 11, 12; 13, 14 each protrude with respect to the first and second front end faces 7, 8 of the laminated core 2. These protruding sections of conductor elements 3, 4 define first and second conductor protrusions 15, 16; 17, 18 relative to the first and second end faces 7, 8 of the laminated core 2, whereby individual conductor elements 3, 4 can have a comparatively greater length 21 than other conductor elements 3, 4 within the electrical winding to be formed. The comparatively longer conductor elements 3, 4 can be used in particular to form winding connections or connection zones. After the conductor elements 3, 4 have been inserted and positioned according to the desired electrical winding concept, a defined bending or cranking of the first and second conductor protrusions 15, 16 or 17, 18 of the rod-shaped conductor elements 4, 5 in the circumferential direction of the laminated core 2 is carried out. In particular, the first and second winding head 23, 24—FIG. 2b—of the electrical winding of the stator 1 or rotor are thus defined in their basic geometry or shape.

Compared to the originally straight or largely straight conductor protrusions 15, 16 or 17, 18 protruding from the laminated core 2 it is provided, that at least one first bending tool 25, 25′ is attached to the first longitudinal ends 11, 12 of the conductor elements 3, 4 in accordance with an appropriate measure in the course of this bending or forming process. In addition, in particular essentially at the same time or slightly offset in time, at least a second bending tool 26, 26′ is attached or placed at least at some of the second longitudinal ends 13, 14 of the conductor elements 3, 4, as is roughly illustrated in particular in FIG. 2b. The at least one first bending tool 25, 25′ and the at least one second bending tool 26, 26′ can have, in a manner known per se, positively acting receiving pockets or driver elements for the longitudinal ends 11, 12; 13, 14 or end faces of the conductor elements 3, 4. However, it is also possible that the bending tools 25, 25′, 26, 26′ are primarily based on a frictional locking principle or on another driving principle for the controlled, plastic forming of the conductor elements 3, 4.

In particular, the conductor protrusions 15, 16; 17, 18 of the conductor elements 3, 4 are bent in the direction of the circumferential direction of the hollow-cylindrical laminated core 2 by means of the at least one bending tool 25, 25′; 26, 26′ which is rotatably mounted about an axis of rotation 27.

In an effective manner, the at least one first bending tool 25, 25′ and/or the at least one second bending tool 26, 26′ can also be used to displace the respectively assigned longitudinal ends 11, 12; 13, 14 or conductor protrusions 15, 16; 17, 18 of the conductor elements 3, 4 in the axial direction of the laminated core 2 in the receiving grooves 5 and to position them according to a plan or at the respective desired position relative to the end faces 7, 8 of the laminated core 2.

It is essential that at least one calibration device 28, 29 is formed, with which the longitudinal ends 11, 12; 13, 14 of the conductor elements 3, 4 are brought or pressed into a predefined target radial position in relation to the laminated core 2 immediately after the bending process along the circumferential direction of the laminated core 2 by calibrating forces acting radially in the direction towards the axis of rotation 27, as can best be seen from a summary of FIGS. 3 to 6. The calibration forces of the calibration device 28, 29 are exerted by controlled or actively adjustable calibration fingers 30, 31 which are aligned radially with respect to the axis of rotation 27 of the at least one bending tool 25, 25′, 26, 26′.

In particular, it is useful if the calibration forces applied via the calibration fingers 30, 31 are exerted opposite the longitudinal ends 11, 12; 13, 14 of the conductor elements 3, 4, while the at least one bending tool 25, 25′; 26, 26′ is still in contact or still in positive engagement with the longitudinal ends 11, 12; 13, 14 of the conductor elements 3, 4. In particular, during this calibration process, the longitudinal ends 11, 12; 13, 14 of the conductor elements 3, 4 are supported by the at least one bending tool 25, 25′, 26, 26′ in their target offset angle or in the immediate vicinity of their target offset angle relative to the laminated core 2 and are guided in the radial direction towards the axis of rotation 27.

Typically, two or more conductor elements 3, 4 are provided in each receiving groove 5 in a radial direction towards the main axis 6 in a row to form two or more concentric layers 9, 10 of conductor elements 3, 4 in the laminated core 2. Here, it can be useful if the opposite longitudinal ends 11, 13 of the conductor elements 3 within the radially inner layer 9 are bent in opposite directions with respect to the circumferential direction of the laminated core 2 by means of the corresponding bending tools 25′, 26′ simultaneously or at least phased simultaneously, or are twisted, and/or if simultaneously or at least in phases simultaneously the opposite longitudinal ends 12, 14 of the conductor elements 4 of the immediately adjacent, radially outer layer 10 are bent or twisted in opposite directions by means of the corresponding, further bending tools 25, 26 by a defined angle of rotation in relation to the circumferential direction of the laminated core 2.

In accordance with an advantageous measure, it may also be provided that the main axis 6 of the laminated core 2 is brought into a horizontal orientation or that a horizontal orientation of the main axis 6 of the laminated core 2 is maintained before the bending process is carried out or rather during the bending process of the first and second longitudinal ends 11, 12; 13, 14 or the first and second conductor protrusions 15, 16; 17, 18 of the conductor elements 3, 4.

As can best be seen from FIG. 6 or from an overview of FIG. 4, 5, the at least one bending tool 25, 25′, 26, 26′ is surrounded on its outer circumference by a respectively corresponding calibration device 28, 29. As further best seen in FIG. 4, the calibration device 28, 29 comprises a plurality of calibration fingers 30, 31 which are aligned radially with respect to the axis of rotation 27 of the at least one bending tool 25, 25′, 26, 26′. These calibration fingers 30, 31 are adjustable by means of at least one actuator 32, 33 in radial direction towards the axis of rotation 27 and in radial direction away from the axis of rotation 27.

The at least one setting device 32, 33 for the calibration fingers 30, 31 can be formed by at least one linear drive 34, 35, in particular by a plurality of working cylinders. The actuator 32, 33 acts on a plurality of link guides 36, 37 in such a way that the calibration fingers 30, 31 can be moved in a radial direction towards the axis of rotation 27 and in a radial direction away from the axis of rotation 27.

The calibration device 28, 29 has at least one support body 38, 39 with a centrally arranged circular clearance 40, which clearance 40 has a diameter 41 which is larger than an outer diameter 42 of the at least one bending tool 25, 25′, 26, 26′ which is accommodated or can be accommodated therein.

The at least one bending tool 25, 25′, 26, 26′ is preferably—as can best be seen from FIG. 5—hollow-cylindrical or cup-shaped. On one of the end faces 43 of its hollow-cylindrical portion 44, which protrudes from its pivot bearing or drive shaft, a plurality of driving webs 45 are formed which are distributed around its circumference and extend radially with respect to the axis of rotation 27. Between the driving webs 45, which follow each other in the circumferential direction, clearances 46 or driving gaps are formed. These clearances 46 or driver gaps—which are formed in the manner of tooth gaps of a gear—are provided for the preferential form-fit reception of partial sections or longitudinal ends 11, 12; 13, 14 of conductor elements 3, 4 to be bent with the bending tool 25, 25′; 26, 26′.

The driving webs 45 can be designed in the form of radially running tooth flanks, as can best be seen in FIGS. 5, 6. The clearances 46 in between are not limited in radial direction with respect to the axis of rotation 27, but are rather open or continuous. In particular, the clearances 46 do not have a pocket shape limited on three sides. Rather, the clearances 46 are slots for the corresponding longitudinal ends 11, 12; 13, 14 of conductor elements 3, 4 extending in the radial direction.

An available adjustment path of the calibration fingers 30, 31 is dimensioned in such a way that calibration tips 47 on the calibration fingers 30, 31 can penetrate at least into the clearances 46 between the driving webs 45 of the radially outer bending tools 25, 26 in the course of a calibration procedure, as can be seen in FIG. 6. In the course of a bending process of the conductor ends 11, 12; 13, 14 by means of the at least one bending tool 25, 25′, 26, 26′ the calibration tips 47 can be positioned outside the clearances 46. It may also be useful if at least two, preferably three or four calibration fingers 47 are grouped together and each group of calibration fingers 47 is actively mounted so as to be actively adjustable in the radial direction relative to the axis of rotation 27 via a common guide or slide element 48.

As can best be seen from FIGS. 2b and 3, at least one motion drive 49, 50 is provided for the at least one rotatably mounted bending tool 25, 25′, 26, 26′. At least one electronic control device 51—FIG. 2b—serves at least for the controlled activation of the at least one first motion drive 49, 50. This at least one control device 51 can also be used for the position-, force- and/or time-controlled activation and deactivation of the other drives or actuators of the manufacturing facility.

The bending tools 25, 25′, 26, 26′, which are rotatably mounted around the axis of rotation 27, are supported or mounted on at least one support frame 52, 53. In addition, the calibration devices 28, 29 are also mounted on this support frame 52, 53 for the bending tools 25, 25′, 26, 26′. In particular, the calibration device 28, 29 illustrated in FIG. 4 is fixed or rigidly mounted on the support frame 52, 53 shown in FIG. 5, with the calibration fingers 30, 31 then running radially with respect to the axis of rotation 27 of the at least one bending tool 25, 25′, 26, 26′. Accordingly, the at least one bending tool 25, 25′, 26, 26′ is surrounded or enclosed on its outside by the at least one calibration device 28, 29. In particular, the calibration device 28 of the first bending device can be assigned to the bending tools 25, 25′ or form a constructional unit with them, while the further calibration device 29 of the bending device is assigned to the bending device with the further bending tools 26, 26′ and forms a constructional unit with them, as can be seen in FIGS. 2b and 3.

In order to achieve a reliable or precise calibration process in relation to the longitudinal ends 11, 12; 13, 14 of the conductor elements 3, 4, it can be provided that the conductor elements 3, 4 are pressed in the direction towards the axis of rotation 27 starting from the calibration fingers 30, 31, which are radially adjustable in the direction towards the axis of rotation 27, and in doing so the radially innermost conductor elements 3 are pressed against an outer surface 54 of a support mandrel 55—FIG. 6—via the conductor elements 4 which are located radially further out. This support mandrel 55 may have a smaller diameter 56 than an inner diameter 57 of the innermost layer 9 of conductor elements 3—FIG. 1—when assuming its target radial position.

Alternatively, it is also possible that the support mandrel 55, which is inserted or is to be inserted into the ring arrangement or into the inner layer 9 of conductor elements 3, 4 in the course of a calibration process, has a larger diameter 56 than an inner diameter 57 of the innermost layer 9 of conductor elements 3 when assuming its target radial position. In particular, the support mandrel 55 can also be frustoconical and can have this larger diameter 56 within at least one axial cross-sectional plane of its frustoconical shape, so that the conductor elements 3, 4 are pressed outwards at least slightly in the radial direction towards the main axis 6 during the insertion or slide-in of the support mandrel 55 into the ring arrangement of conductor elements 3, 4 or into the inner layer 9 of conductor elements 3.

The examples show possible embodiment variations, whereby it should be noted at this point that the invention is not limited to the specially presented embodiment variations, but rather that various combinations of the individual embodiment variations are also possible and that this possibility of variation is due to the teaching of technical action by means of the invention in question in the skill of the person skilled in this technical field.

The scope of protection is determined by the claims. However, the description and the drawings shall be used to interpret the claims. Individual features or combinations of features from the different embodiment examples shown and described can represent independent inventive solutions. The object underlying the independent inventive solutions can be found in the description.

All information on value ranges in the description in question is to be understood in such a way that it includes any and all sub-ranges thereof, e.g. 1 to 10 is to be understood in such a way that all sub-ranges starting from the lower limit 1 and the upper limit 10 are included, i.e. all sub-ranges start with a lower limit of 1 or greater and end with an upper limit of 10 or less, e.g. 1 to 1.7, or 3.2 to 8.1, or 5.5 to 10.

For the sake of order, it should be pointed out in conclusion that, for a better understanding of the structure, elements have sometimes been shown in an unscaled and/or enlarged and/or reduced scale.

List of reference numbers

| | |
|---|---|
| 1 | Stator |
| 2 | Laminated core |
| 2′ | Sheet metal segments |
| 3 | Conductor element |
| 4 | Conductor element |
| 5 | Receiving groove |
| 6 | Main axis |
| 7 | First end face |
| 8 | Second end face |
| 9 | First layer |
| 10 | Second layer |
| 11 | First longitudinal end |
| 12 | First longitudinal end |
| 13 | Second longitudinal end |
| 14 | Second longitudinal end |
| 15 | First conductor protrusion |
| 16 | First conductor protrusion |
| 17 | Second conductor protrusion |
| 18 | Second conductor protrusion |
| 19 | Insulation layer |
| 20 | Insulation element |
| 21 | Length |
| 22 | Axial length |
| 23 | First winding head |
| 24 | Second winding head |
| 25, 25′ | First bending tool |
| 26, 26′ | Second bending tool |
| 27 | Axis of rotation |
| 28 | Calibration device |
| 29 | Calibration device |
| 30 | Calibration finger |
| 31 | Calibration finger |
| 32 | Actuator |
| 33 | Actuator |
| 34 | Linear drive |
| 35 | Linear drive |
| 36 | Link guide |
| 37 | Link guide |
| 38 | Supporting body |
| 39 | Supporting body |
| 40 | Clearance |
| 41 | Diameter |
| 42 | Outer diameter |
| 43 | End face |
| 44 | Hollow-cylindrical portion |
| 45 | Driving web |
| 46 | Clearance |
| 47 | Calibration tips |
| 48 | Slide element |
| 49 | Motion drive |
| 50 | Motion drive |
| 51 | Control device |
| 52 | Support frame |
| 53 | Support frame |
| 54 | Outer surface |
| 55 | Support mandrel |
| 56 | Diameter |
| 57 | Inner diameter |

1. A method for an automated manufacturing of a semi-finished product of a stator of an electrical machine, the method, comprising:
provision of a substantially hollow-cylindrical laminated core with a plurality of stacked sheet metal segments defining a main axis, which laminated core has a plurality of receiving grooves for conductor elements of an electrical winding, which receiving grooves are distributed in the circumferential direction of the laminated core and extend between a first and second axial end face of the laminated core, wherein the conductor elements protrude with at least one of their longitudinal ends with respect to the first and/or second end face of the laminated core and thus form conductor protrusions with respect to the laminated core at at least one of the end faces of the laminated core, and
bending of the conductor protrusions of the conductor elements in the direction of the circumferential direction of the hollow-cylindrical laminated core by means of at least one bending tool rotatably mounted about an axis of rotation, wherein the longitudinal ends of the conductor elements are brought into a predefined target radial position relative to the laminated core by calibration forces acting radially towards the axis of rotation and exerted by at least one calibration device with controllably adjustable calibrating fingers aligned radially with respect to the axis of rotation of the at least one bending tool.

2. The method according to claim 1, wherein the calibration forces applied via the calibration fingers are applied relative to the longitudinal ends of the conductor elements, while the at least one bending tool is connected to the longitudinal ends of the conductor elements and is still in contact or still in positive engagement therewith, so that the longitudinal ends of the conductor elements are held by the at least one bending tool positioned at their target offset angle or in the immediate vicinity of their target offset angle relative to the laminated core and are guided in the radial direction towards the axis of rotation.

3. The method according to claim 1, wherein the conductor elements are pressed in the direction towards the axis of rotation, starting from the calibration fingers which are adjustable radially in the direction towards the axis of rotation, and in the process the radially innermost conductor elements are pressed against an outer surface of a support mandrel via conductor elements located radially further out.

4. The method according to claim 3, wherein the support mandrel has a smaller diameter than an inner diameter of the innermost layer of conductor elements when taking up their target radial position.

5. The method according to claim 3, wherein the support mandrel has a larger diameter than an inner diameter of the innermost layer of conductor elements when taking up their target radial position, in particular in the form of a truncated cone and has this larger diameter within at least one axial cross-sectional plane of its truncated cone shape, so that the conductor elements are pressed radially outwards during the insertion or slide-in of the support mandrel into the ring arrangement of conductor elements.

6. The method according to claim 1, wherein two or more conductor elements juxtaposed in a radial direction towards the main axis of the laminated core are arranged in each receiving groove to form two or more concentric layers of conductor elements, wherein the mutually opposite longitudinal ends of the conductor elements arranged within a radially inner layer by means of the corresponding bending tools are simultaneously or at least at times simultaneously bent in opposite directions with respect to the circumferential direction of the laminated core, and/or that simultaneously or at least at times simultaneously the opposite longitudinal ends of the conductor elements of an immediately adjacent, radially outer layer are bent in opposite directions by means of the corresponding, further bending tools by a defined angle of rotation with respect to the circumferential direction of the laminated core.

7. The method according to claim 1, wherein bringing the main axis of the laminated core into a horizontal orientation or rather by maintaining a horizontal orientation of the main axis of the laminated core before the bending operation, respectively during the bending operation, of the first and second longitudinal ends and/or the first and second conductor protrusions of the conductor elements is carried out.

8. A device for the automated manufacturing of a semi-finished product of a stator of an electrical machine, comprising
a support frame for holding at least one bending tool mounted rotatably about an axis of rotation,
wherein the at least one bending tool is hollow-cylindrical or cup-shaped and has, on one end face of its hollow-cylindrical portion, a plurality of radially with respect to the axis of rotation extending driving webs arranged in a distributed manner in the circumferential direction of the latter, clearances being formed between each of the driving webs adjoining one another in the circumferential direction, which clearances are provided for receiving partial sections or longitudinal ends of conductor elements to be bent with the bending tool,
with at least one motion drive for the at least one rotatably mounted bending tool,
and with at least one electronic control device for controlled activation of the at least one motion drive, wherein
the at least one bending tool is surrounded on its outer circumference by at least one calibration device,
which at least one calibration device comprises a plurality of calibration fingers aligned radially with respect to the axis of rotation of the at least one bending tool, and in that the calibration fingers are adjustable in the direction towards the axis of rotation and in the direction away from the axis of rotation by means of at least one actuator.

9. The device according to claim 8, wherein the at least one calibration device comprises a support body with a centrally arranged circular clearance, which clearance has a diameter which is larger than an outer diameter of the at least one bending tool accommodated therein.

10. The device according to claim 8, wherein an adjustment path of the calibration fingers is dimensioned in such a way that calibration tips on the calibration fingers can penetrate into the clearances between the driving webs in the course of a calibration operation, and in that the calibration tips can be positioned outside the clearances in the course of a bending operation by means of the at least one bending tool.

11. The device according to claim 8, wherein the actuator for the calibration fingers is formed by at least one linear drive, in particular by a plurality of working cylinders, which actuator acts on a plurality of link guides in such a way that the calibration fingers can be moved in the radial direction towards the axis of rotation and in the radial direction away from the axis of rotation.

12. The device according to claim 8, wherein the at least one calibration device and the at least one bending tool are mounted on a common support frame.
